(19) United States
(12) Patent Application Publication
(10) Pub. No.: US 2014/0231694 A1
(43) Pub. Date: Aug. 21, 2014

(54) VALVE HAVING AN ENHANCED COLD START CAPABILITY

(71) Applicants: Elmar OKRENT, Remseck (DE); Frank MILLER, Ilsfeld (DE)

(72) Inventors: Elmar OKRENT, Remseck (DE); Frank MILLER, Ilsfeld (DE)

(73) Assignee: ROBERT BOSCH GMBH, Stuttgart (DE)

(21) Appl. No.: 14/178,195

(22) Filed: Feb. 11, 2014

(30) Foreign Application Priority Data
Feb. 19, 2013 (DE) 10 2013 202 623.4

(51) Int. Cl. F16K 25/00

(52) U.S. Cl. CPC F16K 25/00
USPC 251/334

(57) ABSTRACT

A valve for controlling a medium, e.g., a gaseous medium, includes: a valve support having at least one passage aperture; a closing element which is configured to open and to close the at least one passage aperture; and a valve seat including at least one area projecting in the axial direction of the valve, the projecting area being coated with an elastomeric sealing element, and the elastomeric sealing element being exclusively situated on the projecting area of the valve seat.

### BACKGROUND OF THE INVENTION

1. Field of the Invention

The present invention relates to a valve for controlling a medium, e.g., a gaseous medium, having an enhanced cold start capability.

2. Description of the Related Art

Valves for controlling media are known in a variety of embodiments from the related art. In the motor vehicle field, gaseous fuels such as natural gas or biogas are being increasingly used in addition to liquid fuel. However, in particular the valves previously used for liquid fuels frequently do not meet the requirements of gas valves for gaseous fuels. A valve for gaseous hydrogen is known from Published German patent application document DE 10 2010 043 641 A1, for example, in which three annular passages are situated in a valve seat support, which each have a web between each other. A height of the webs in the axial direction of the valve is smaller than a distance between an inlet opening and an outlet opening on the valve seat support. However, in particular the manufacture of this valve seat support is very complex and thus cost-intensive. In addition, manufacturers of gas valves in particular also have to design the gas valves for different engines of different engine manufacturers, in addition to the requirements of different gaseous media. In addition to high development complexity for the different variants, production also requires a wide variety of production lines to be installed, which makes the manufacture of such valves more expensive.

### BRIEF SUMMARY OF THE INVENTION

The valve according to the present invention, in particular a gas valve, for controlling a medium has the advantage over the related art that it is particularly cost-effective to provide and has an enhanced cold start capability, in particular at temperatures below 0° C. This is achieved according to the present invention in that the valve includes a valve seat which has a projecting area in an axial direction of the valve. The projecting area is coated with an elastomeric sealing element, the elastomeric sealing element being situated exclusively on the projecting area of the valve seat. According to the present invention, in this way only the relevant contact surfaces of the valve seat are provided with the elastomeric sealing element. Moreover, the idea according to the present invention provides a very robust design, and a modular and cost-effective construction is possible. Nonetheless the necessary sealing requirements may be met, in particular in the customary temperature range from −40° C. to +100° C., thus also solving the problem that exists in the related art of the immersion of the valve seat into an elastic sealing element, which may result in an increased contact surface between the sealing element and the valve seat.

The elastomeric sealing element preferably has a small thickness in the axial direction of the valve. The thickness of the elastomeric sealing element particularly preferably ranges from 50 μm to 300 μm, in particular 100 μm to 150 μm. These ranges in particular ensure that an excessive adherence of the elastomeric sealing element in the closed state of the valve is prevented, even at low temperatures below 0° C.

The valve seat is particularly preferably situated on the valve support. According to one alternative embodiment of the present invention, the valve seat is preferably situated on the closing element. It is thus possible according to the present invention to situate the valve seat including the projecting area only on one of the two components.

It is further preferred if the elastomeric sealing element is applied to the valve seat with the aid of micro injection molding or with the aid of screen printing. These two methods allow the elastomeric sealing element to be applied very precisely and reliably to the valve seat, so that no undesirable overhang or the like is present on the valve seat. In this way a direct integral joint between the valve seat and the sealing element is achieved.

It is further preferred if a height of the valve seat in the axial direction of the valve is in a range from equally as high to 3 times the thickness of the elastomeric sealing element in the axial direction.

According to one further preferred embodiment of the present invention, the valve includes a planar closing surface which seals on the valve seat. In other words, the valve seat is provided on one of the two components that are the valve support or closing element and the other of the two components includes the planar closing surface. This not only ensures a simple geometry of the valve, but also that an immersion into the elastomer element is prevented.

It is further preferred if the valve includes a stop which is formed between the valve support and the closing element. An exact deformation of the elastomeric sealing element is thus definable in the closed state of the valve.

According to one further preferred embodiment of the present invention, the valve includes an intermediate element which is situated between the valve support and the closing element, the intermediate element including the valve seat. In this way in particular a high number of identical parts is made possible since the intermediate element in each case is also adaptable to the specific requirements, for example of a particular engine manufacturer. The intermediate element is particularly preferably a disk, in particular a stamped embossed part in the form of a disk. It is further preferred if a thickness of the intermediate element is approximately 2 to 3 times the thickness of the sealing element.

The valve according to the present invention is preferably designed as a gas valve and is used to control in particular gaseous media, such as natural gas or biogas. The gas valve is particularly preferably an injection valve for injecting gaseous fuel into a combustion chamber.

Preferred exemplary embodiments of the present invention will be described in greater detail hereafter with reference to the accompanying drawing. Identical or functionally equivalent parts are denoted by the same reference numerals.

### BRIEF DESCRIPTION OF THE DRAWINGS

FIG. 1 shows a schematic sectional view of a gas vale according to one first exemplary embodiment of the present invention.

FIG. 2 shows a schematic sectional view of a valve support of FIG. 1.

FIGS. 3 through 5 show additional preferred exemplary embodiments of gas valves according to the present invention.

### DETAILED DESCRIPTION OF THE INVENTION

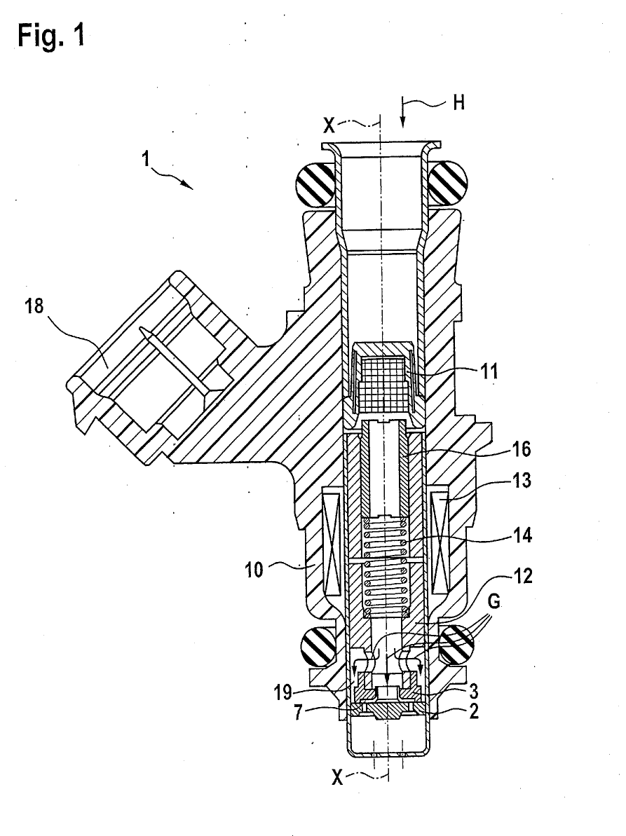

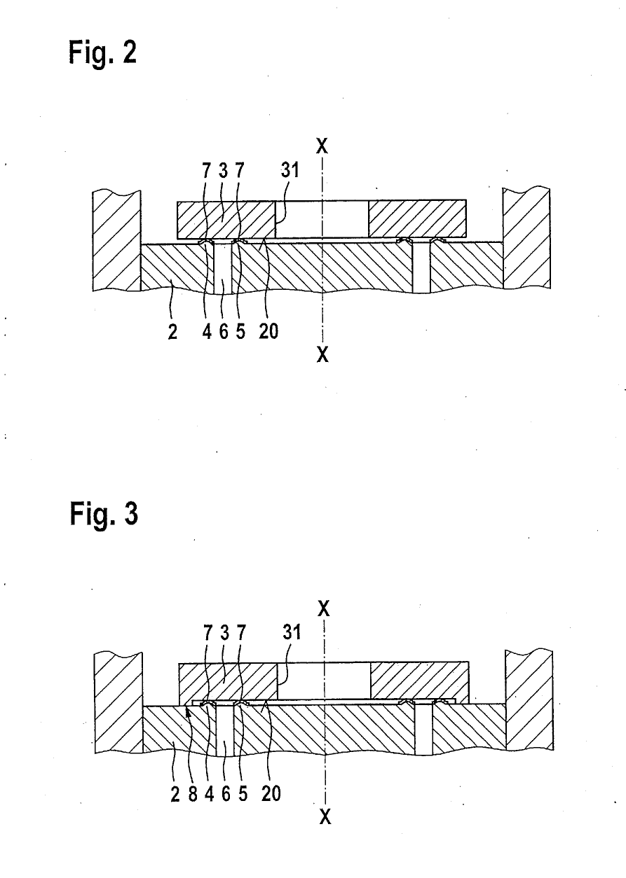

A gas valve 1 according to one first exemplary embodiment of the present invention will be described in greater detail hereafter with reference to FIGS. 1 and 2.

Gas valve 1 of the first exemplary embodiment is an injection valve for injecting fuel into a combustion chamber. Gas valve 1 includes a valve housing 10, an armature 12, a solenoid 13 and a closing spring 14. A setting bolt 16 is provided to set a return force of closing spring 14. The gas is supplied in the axial direction (arrow H) and conducted through a filter 11. Solenoid 13 is fixed on valve housing 10 in an extrusion coating made of plastic. An electrical plug connection 18 is provided laterally on gas valve 1.

A closing element 3 is attached to an axial end of armature 12. Closing element 3 closes passage apertures 6 which are formed in a valve support 2. FIG. 1 shows the closed state of gas valve 1. Arrows G indicate a flow direction of the gaseous fuel when the gas valve is open, the gas being injected into a combustion chamber through a space 19 in valve housing 10 and through passage apertures 6. A central aperture (see FIG. 2), via which gas may also flow to passage apertures 6, is further provided in closing element 3.

As is apparent from the enlarged detailed view of FIG. 2, a first valve seat including an area 4 projecting in the axial direction X-X of the valve and a second valve seat including an area 5 projecting in the axial direction X-X are provided on valve support 2. Multiple kidney-shaped passage apertures 6 are situated between projecting areas 4, 5 of the valve seats.

As is also apparent from FIG. 2, projecting areas 4, 5 of the valve seats are in each case coated with an elastomeric sealing element 7. Elastomeric sealing element 7 is provided exclusively on projecting areas 4, 5 of the valve seats. In this way only the relevant contact surfaces of the valve seats are provided with elastomeric sealing element 7, so that a very good cold start capability of the valve is achieved. In particular no overhang or the like is provided, which would result in an increased contact surface of the sealing element with the closing element in the closed state.

A thickness of elastomeric sealing elements 7 on projecting areas 4, 5 of the valve seats is selected to be relatively small. A planar closing surface 20 is furthermore provided on closing element 3, whereby it is prevented in the closed state that closing element 3 can penetrate into elastomeric sealing elements 7 and thereby a cold start capability of the valve is possibly worsened. Planar closing surface 20 ensures that, in the closed state of the valve, not only the tightness of the valve is ensured across all relevant temperature and pressure ranges, but also a maximally permissible pressure load of the elastomeric sealing element material continues to be adhered to.

Elastomeric sealing elements 7, which are selectively applied only to projecting areas 4, 5 of the valve seats, may be applied to the projecting areas very precisely and in a narrowly defined scope with the aid of micro injection molding or with the aid of screen printing, for example.

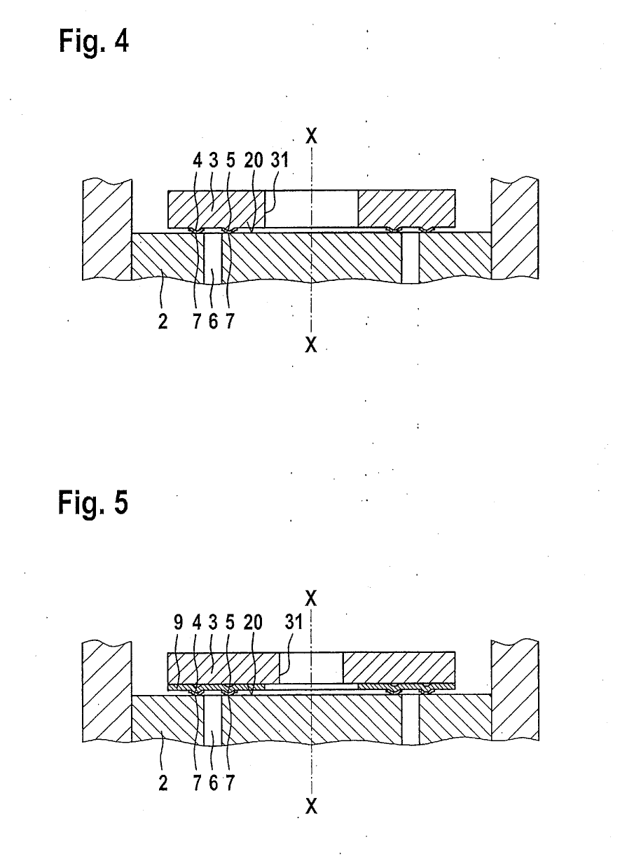

FIG. 3 shows a gas valve 1 according to a second exemplary embodiment of the present invention, which essentially corresponds to the first exemplary embodiment. Contrary to the first exemplary embodiment, a stop 8 is additionally provided in the second exemplary embodiment. Stop 8 is formed by an annular protrusion on closing element 3. Stop 8 ensures that a predefined deformation of elastomeric sealing element 7 is always adhered to in the closed state under all operating conditions. Stop 8 is designed for this purpose as a metallic stop between valve support 2 and closing element 3.

FIG. 4 shows a gas valve according to the third exemplary embodiment of the present invention. This exemplary embodiment essentially corresponds to the first exemplary embodiment; however, contrary to the first exemplary embodiment, the first and second valve seats having projecting areas 4, 5 are situated on closing element 3 in the third exemplary embodiment. Moreover, planar closing surface 20 is provided on valve support 2. As in the preceding exemplary embodiments, elastomeric sealing elements 7 are formed only on projecting areas 4, 5 of the valve seats.

Contrary to the preceding exemplary embodiments, an intermediate element 9 is provided in the fourth exemplary embodiment shown in FIG. 5. Intermediate element 9 includes the first and second valve seats having projecting areas 4, 5. Intermediate element 9 is a metallic plate which may be produced, for example, with the aid of stamping and embossing projecting areas 4, 5. In this exemplary embodiment, intermediate element 9 is situated on closing element 3 and may be joined to closing element 3 with the aid of known joining techniques. Planar closing surface 20 is again provided on valve seat support 2. The fourth exemplary embodiment in particular has the advantage that the closing properties of the valve are changeable in a simple and very cost-effective manner by replacing intermediate element 9. For example, a different embossing of projecting areas 4, 5 in intermediate element 9 may be carried out for different engine manufacturers. As a result of this idea according to the present invention of providing an intermediate element 9, a plurality of variants of intermediate element 9 may be easily preproduced and stored, for example, and then joined without great complexity to the remaining components of the gas valve to provide a manufacturer-specific gas valve. Moreover, a certain level of damping during the closing process exists as a result of the provision of intermediate element 9 as a disk having embossed projecting areas 4, 5, since a space behind projecting areas 4, 5 is hollow and thus minimal, reversible deformation of the projecting areas is possible during the closing process. It is thus possible in particular to achieve a modular construction of the gas valve and a particularly cost-effective and robust design, due to the fourth exemplary embodiment of the gas valve.

It shall further be noted with regard to all exemplary embodiments in FIGS. 1 through 5 described in detail that, in addition to an excellent cold start capability, these also make it possible that lower requirements are placed on tolerances of the individual components. The cost of manufacturing the gas valve according to the present invention is thus significantly reduced. Since according to the present invention exclusively projecting areas 4, 5 of the valve seats are coated with elastomeric sealing element 7, there is no risk of undesirable adherence in the closed state of the gas valve.

What is claimed is:

1. A valve for controlling a gaseous medium, comprising:
a valve support having at least one passage aperture;
a closing element configured to open and close the at least one passage aperture; and
a valve seat, wherein the valve seat includes at least one area projecting in the axial direction of the valve, the projecting area being coated with an elastomeric sealing element, wherein the elastomeric sealing element is exclusively situated on the projecting area of the valve seat.

2. The valve as recited in claim 1, wherein the elastomeric sealing element has a thickness of 100 μm to 150 μm.

3. The valve as recited in claim 1, wherein the valve seat including the projecting area is situated on the valve support.

4. The valve as recited in claim 1, wherein the valve seat including the projecting area is situated on the closing element.

5. The valve as recited in claim 3, wherein the elastomeric sealing element is applied to the projecting area with the aid of one of micro injection molding or screen printing.

6. The valve as recited in claim 3, wherein a height of the valve seat in the axial direction ranges from one to three times the thickness of the elastomeric sealing element in the axial direction.

7. The valve as recited in claim 4, wherein the valve seat seals a planar closing surface.

8. The valve as recited in claim 1, further comprising:
a stop which is formed between the valve support and the closing element.

9. The valve as recited in claim 1, wherein an intermediate element is situated between the valve support and the closing element, the intermediate element including the valve seat having the projecting area.

10. The valve as recited in claim 9, wherein the intermediate element is a disk.

11. The valve as recited in claim 4, wherein the elastomeric sealing element is applied to the projecting area with the aid of one of micro injection molding or screen printing.

12. The valve as recited in claim 4, wherein a height of the valve seat in the axial direction ranges from one to three times the thickness of the elastomeric sealing element in the axial direction.
